(19) United States
(12) Patent Application Publication
(10) Pub. No.: US 2022/0207322 A1
(43) Pub. Date: Jun. 30, 2022

(54) DATA PROCESSING METHOD AND APPARATUS BASED ON NEURAL POPULATION CODING, STORAGE MEDIUM, AND PROCESSOR

(71) Applicant: INFORMATION SCIENCE ACADEMY OF CHINA ELECTRONICS TECHNOLOGY GROUP CORPORATION, Beijing (CN)

(72) Inventors: Wentao HUANG, Beijing (CN); Sen YUAN, Beijing (CN); Mengbin RAO, Beijing (CN); Jianjun GE, Beijing (CN)

(21) Appl. No.: 17/544,115

(22) Filed: Dec. 7, 2021

(30) Foreign Application Priority Data
Dec. 25, 2020 (CN) 202011567545.2

(51) Int. Cl. G06N 3/04

(52) U.S. Cl. CPC G06N 3/04

(57) ABSTRACT

A data processing method and apparatus based on neural population coding, a storage medium, and a processor are provided. The method includes: obtaining raw data and performing a common spatial pattern transformation on the raw data to obtain transformed data; obtaining, based on the transformed data, a first target function including a first matrix, where the first target function is a target function of a neural population coding network model of the raw data, and the first matrix is a weight parameter of the target function of the neural population coding network model; updating the first matrix according to a preset gradient descent update rule, to obtain a second matrix; and updating the first target function based on the second matrix.

### CROSS-REFERENCE TO RELATED APPLICATION

The present application claims priority of Chinese Application No. 202011567545.2, entitled “Data Processing Method and Apparatus Based on Neural population coding, Storage Medium, and Processor” filed on Dec. 25, 2020, which is incorporated by reference in its entirety.

### TECHNICAL FIELD

The present disclosure relates to the field of machine learning, and specifically, to a data processing method and apparatus based on neural population coding, a storage medium, and a processor.

### BACKGROUND

Machine learning has been widely applied to many fields such as data mining, computer vision, natural language processing, physiological feature recognition, and the like. The key of machine learning is to find an unknown structure in data and learn a good feature representation from observation data. Such a feature representation helps to reveal an underlying data structure. At present, machine learning mainly includes two types of methods: supervised learning and unsupervised learning. Supervised learning is a machine learning task of inferring a function from labeled training data, and the training data consists of a set of training examples. In supervised learning, each example consists of an input object (typically a vector) and a desired output value (also referred to as a supervisory signal). A supervised learning algorithm analyzes the training data and produces an inferred function, which can be used for mapping new examples.

At present, main applications of supervised representation learning include support-vector machines (SVMs) suitable for a shallow model and backpropagation (BP) algorithms suitable for a deep learning model. At present, an SVM is only suitable for a shallow model and a small sample and is difficult to be extended to a deep model. A BP algorithm is currently a main fundamental algorithm for deep learning. However, a large number of training examples are required to achieve a good effect, and there are disadvantages such as low training efficiency and poor robustness.

No effective solution has been proposed to solve the problems of low training efficiency and poor robustness in a supervised learning model in the conventional technology.

### SUMMARY

Embodiments of the present disclosure provide a data processing method and apparatus based on neural population coding, a storage medium, and a processor, to at least solve the technical problems of low training efficiency and poor robustness in a supervised learning model in the conventional technology.

According to an aspect of the embodiments of the present disclosure, a data processing method based on neural population coding is provided, the method including: obtaining raw data and performing a common spatial pattern transformation on the raw data to obtain transformed data; obtaining, based on the transformed data, a first target function including a first matrix, where the first target function is a target function of a neural population coding network model, and the first matrix is a weight parameter of the target function of the neural population coding network model; updating the first matrix according to a preset gradient descent update rule, to obtain a second matrix; and updating the first target function based on the second matrix.

Further, the obtaining raw data and performing common spatial pattern transformation on the raw data to obtain transformed data includes: obtaining an input vector representing the raw data and a neuron output vector; determining an interactive information formula based on the input vector of the raw data and the neuron output vector; determining a second target function including a covariance matrix and a transformation matrix; obtaining the transformation matrix based on the interactive information formula and the second target function; and transforming the raw data into the transformed data based on the transformation matrix.

Further, if the number of neuron output vectors is greater than the number of vector dimensions of the raw data, the obtaining the transformation matrix based on the interactive information formula and the second target function includes: obtaining a close approximation formula for the interactive information formula; and obtaining the transformation matrix based on the close approximation formula and the second target function.

Further, the updating the first matrix according to a preset gradient descent update rule, to obtain a second matrix includes: updating the first matrix according to the preset gradient descent update rule, to obtain a third matrix; determining the number of iterations, where the number of iterations is used to indicate the number of times of updating the first matrix according to the preset gradient descent update rule; and determining whether the number of iterations reaches a preset number; and if the number of iterations reaches the preset number, outputting the third matrix as the second matrix, or if the number of iterations does not reach the preset number, assigning the third matrix to the first matrix, and returning to the step of updating the first matrix according to the preset gradient descent update rule, to obtain a third matrix.

Further, before the updating the first matrix according to the preset gradient descent update rule, to obtain a third matrix, the method further includes: calculating a derivative of the first target function with respect to the first matrix.

Further, the updating the first target function based on the second matrix includes: performing an orthogonal transformation on the second matrix, to obtain an orthogonal result; and updating a value of the first target function based on the orthogonal result.

Further, the orthogonal transformation is a Gram-Schmidt orthogonal transformation.

According to another aspect of the embodiments of the present disclosure, a data processing apparatus based on neural population coding is further provided. The apparatus includes: a transformation module configured to obtain raw data and perform a common spatial pattern transformation on the raw data to obtain transformed data; a function obtaining module configured to obtain, based on the transformed data, a first target function including a first matrix, where the first target function is a target function of a neural population coding network model, and the first matrix is a weight parameter of the target function of the neural population coding network model; a matrix update module configured to: update the first matrix according to a preset gradient descent update rule, to obtain a second matrix; and a function update module configured to update the first target function based on the second matrix.

According to another aspect of the embodiments of the present disclosure, a storage medium is further provided. The storage medium includes a stored program, and when the program is run, a device having the storage medium is controlled to perform the foregoing data processing method based on neural population coding.

According to another aspect of the embodiments of the present disclosure, a processor is further provided. The processor is configured to run a program, and when the program is run, the foregoing data processing method based on neural population coding is performed.

In the embodiments of the present disclosure, according to the supervised representation learning algorithm based on neural population coding proposed in the above steps, the CSP transformation is performed on the obtained raw data to obtain the transformed data, and the supervised learning target function of the neural population coding network model is constructed based on the transformed data, to update the weight parameter matrix in the model according to the preset gradient descent update rule, such that fast optimization of the weight parameter in the neural population coding network model is implemented.

### BRIEF DESCRIPTION OF THE DRAWINGS

The drawings described herein, which constitute a part of the present disclosure, provide a further understanding of the present disclosure. The schematic embodiments of the present disclosure and descriptions thereof are intended to explain the present disclosure, and do not constitute inappropriate limitation on the present disclosure. In the drawings:

FIG. 1 is a flowchart of a data processing method based on neural population coding according to an embodiment of the present disclosure;

FIG. 2 is a flowchart of an optional data processing method based on neural population coding according to an embodiment of the present disclosure;

FIG. 3 is an exemplary diagram of an MNIST dataset of handwritten digits;

FIG. 4 is a schematic diagram of a weight parameter C obtained by learning after processing on the dataset in FIG. 3 according to an embodiment of the present disclosure; and

FIG. 5 is a schematic diagram of a data processing apparatus based on neural population coding according to an embodiment of the present disclosure.

### DETAILED DESCRIPTION OF EMBODIMENTS

In order to make those skilled in the art better understand solutions in the present disclosure, the technical solutions in the embodiments of the present disclosure will be clearly and completely described below with reference to the drawings in the embodiments of the present disclosure. Obviously, the described embodiments are merely some of rather than all the embodiments of the present disclosure. All other embodiments obtained by those of ordinary skill in the art based on the embodiments of the present disclosure without any creative effort shall fall within the scope of protection of the present disclosure.

It should be noted that, in the description, claims and drawings of the present disclosure, the terms such as “first” and “second” are used for distinguishing similar objects, but are not used for describing a particular sequence or order among the objects. It should be understood that the data termed in such a way is interchangeable in proper circumstances so that the embodiments of the present disclosure described herein can be implemented in an order other than the order illustrated or described herein. Moreover, the terms “include”, “contain” and any other variants mean to cover the non-exclusive inclusion, for example, a process, method, system, product, or device that includes a list of steps or units is not necessarily limited to those expressly listed steps or units, but may include other steps or units not expressly listed or inherent to such a process, method, system, product, or device.

According to the embodiments of the present disclosure, an embodiment of a data processing method based on neural population coding is provided. It should be noted that, steps shown in the flowcharts in the drawings may be performed in a computer system such as a set of computer-executable instructions. In addition, although a logical order is shown in the flowcharts, in some cases, the steps shown or described may be performed in an order different from that described herein.

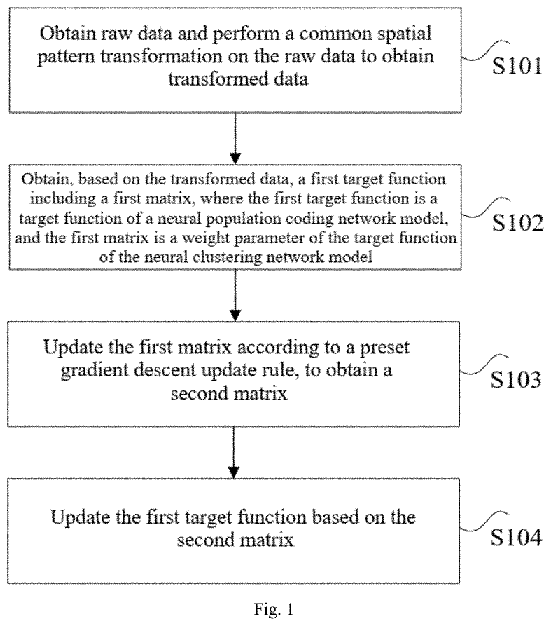

FIG. 1 shows a data processing method based on neural population coding according to an embodiment of the present disclosure. As shown in FIG. 1, the method includes the following steps.

Step S101: Raw data is obtained and a common spatial pattern transformation is performed on the raw data to obtain transformed data.

The raw data is image data, voice data, signal data, or the like from applications such as image recognition, natural language processing, voice recognition, signal analysis, etc.

A CSP transformation is short for a common spatial pattern transformation. According to the following formula, a CSP transformation can be performed on raw data x to obtain transformed data \hat{x}: \hat{x}=V^{T}x, where V^{T} is a transposed matrix of a transformation matrix V. The CSP transformation may preliminarily highlights differences between different classes of raw data, such that further learning and training are subsequently performed for classification to improve learning efficiency.

Step S102: A first target function including a first matrix may be obtained based on the transformed data, where the first target function is a target function of a neural population coding network model, and the first matrix is a weight parameter of the target function of the neural population coding network model.

The first target function is a supervised learning target function in a neural population coding network model. In an optional embodiment, the first target function is Q[C], the first matrix is C, and the first matrix C is a weight parameter of the first target function Q[C]. An expression of the first target function may be as follows:

$$\{ \begin{matrix}minimize Q [ C ] = - 〈 {\sum }_{k = 1}^{K} ln ( {g}^{′} ( {d}_{k} ) ) 〉 \\ subject to {CC}^{T} = {I}_{{K}_{0}}\end{matrix} \\ where \\ {g}_{k} ( {d}_{k} ) = \frac{1}{β} ln ( 1 + {e}^{β {d}_{k}} ) , {g}^{′} ( {d}_{k} ) = \frac{\partial g ( {d}_{k} )}{\partial {d}_{k}} = \frac{1}{1 + {e}^{- β {d}_{k}}} , \\ {d}_{k} = sign ( t ) {c}_{k}^{T} \hat{x} - m ,$$

and β and m are non-negative constants, and m can be regarded as a margin parameter.

Step S103: The first matrix is updated according to a preset gradient descent update rule, to obtain a second matrix.

In an optional embodiment, to differentiate the first matrix from the second matrix, the first matrix C in step S102 is denoted as C^{t}, and the second matrix obtained after the update is denoted as C^{t+1}. The preset gradient descent update rule may be expressed as follows:

$$\{ \begin{matrix}{C}^{t + 1} = {C}^{t} + {μ}_{t} \frac{{dC}^{t}}{dt} \\ \frac{{dC}^{t}}{dt} = - \frac{dQ [ {C}^{t} ]}{{dC}^{t}} + {{C}^{t} ( \frac{dQ [ {C}^{t} ]}{{dC}^{t}} )}^{T} {C}^{t}\end{matrix}$$

where a learning rate parameter μₜ=vₜ/κₜ, 0<v₁<1, t=1, . . . , tₘₐₓ;

$${κ}_{t} = \frac{1}{{K}_{1}} {\sum }_{k = 1}^{K} \frac{‖ ∇ {C}^{t} ( : , k ) ‖}{‖ {C}^{t} ( : , k ) ‖} , and ‖ ∇ {C}^{t} ( : , k ) ‖$$

represents a modulus value of a gradient vector of the first matrix C^{t}.

Step S104: The first target function is updated based on the second matrix.

The second matrix is obtained by iterating and updating the first matrix, and therefore the second matrix is also a weight parameter of the first target function. The obtained second matrix C^{t+1} is substituted into the first target function Q[C] (that is, C is substituted with C^{t+1}), to obtain an updated first target function Q[C]. In this way, the first target function is optimized by updating the weight parameter of the first target function.

According to the supervised representation learning algorithm based on neural population coding proposed in the above steps, the CSP transformation is performed on the obtained raw data to obtain the transformed data, and the supervised learning target function of the neural population coding network model is constructed based on the transformed data, to update the weight parameter matrix in the model according to the preset gradient descent update rule, such that fast optimization of the weight parameter in the neural population coding network model is implemented. The supervised representation learning algorithm is not only applicable to training and learning of large data samples but also applicable to training and learning of small data samples. By means of the CSP transformation, noise of the raw data is filtered out, and differences between different classes of raw data are highlighted, such that efficiency, performance, and robustness of training and learning of the neural population coding network model is improved without increasing calculation complexity, and the problems of low training efficiency and poor robustness in a supervised learning model in the conventional technology are solved.

In an optional embodiment, step S101 of obtaining raw data and performing a common spatial pattern transformation on the raw data to obtain transformed data includes: obtaining an input vector representing the raw data and a neuron output vector; determining an interactive information formula based on the input vector of the raw data and the neuron output vector; determining a second target function including a covariance matrix and a transformation matrix; obtaining the transformation matrix based on the interactive information formula and the second target function; and transforming the raw data into the transformed data based on the transformation matrix.

Because each neuron in a brain nervous system is linked with other thousands of neurons, coding of cranial nerves relates to coding with neuron clusters at a large scale, and a neural population coding network model is established in imitation of neurons in the brain nervous system. Conditional mutual information (namely, interactive information) is understood as an amount of information included in one random variable relative to another random variable under a specific conditional constraint.

The following describes a process of the CSP transformation on the raw data: The input vector representing the raw data and the neuron output vector are obtained, where the input vector x is a K-dimensional vector, the input vector x may be denoted as x=(x₁, . . . , xₖ)^{T}, a data label corresponding to the input vector x is t, the neuron output vector includes N neurons and may be denoted as r=(r₁, . . . , r_{N})^{T}, random variables corresponding to the neuron output vector are denoted in capitals as X, T, and R, and interactive information I of the input vector x and an input vector r is denoted as:

$$I ( R ; X \vert T ) = {〈 ln \frac{p ( r , x \vert t )}{p ( r \vert t ) p ( x \vert t )} 〉}_{r , x , t}$$

where p(r,x|t), and p(r|t), and p(x|t) represent conditional probability density functions, and [symbol] ⋅ [symbol] _{r,x,t} represents an expected value of the probability density function p(x,r,t).

If it is specified that there are only two classes of the corresponding label data t, that is, t∈{1,−1}, covariance matrices of the two classes of label data are denoted as Σ₁ and Σ₂, respectively. The following can be obtained by normalizing the covariance matrices:

$${\overline{Σ}}_{1} = \frac{{Σ}_{1}}{Tr ( {Σ}_{1} )} , {\overline{Σ}}_{2} = \frac{{Σ}_{2}}{Tr ( {Σ}_{2} )} ,$$

where Tr represents a trace of a matrix. The following target function L(V) is minimized to obtain the transformation matrix V:

Minimize L(V)=V^{T}Σ̅₁V subject to V^{T}(Σ̅₁+Σ̅₁)V=1.

V=D^{-1/2}U^{T} and Σ̅ₜ+Σ̅ₜ=UDU^{T} can be obtained by solving the target function L(V), where U is an eigenvector matrix, and D is a diagonal matrix of an eigenvalue.

After the transformation matrix V is obtained, transformed data \hat{x} after the CSP transformation on the input vector x is expressed as \hat{x}=V^{T}x.

In the above steps, the preprocessing of a common spatial pattern (CSP) transformation on the raw data is implemented. After the CSP transformation is completed, subsequent parameter training and learning of the supervised learning target function in a neural population coding network model constructed with the obtained transformed data is implemented. Compared with a supervised learning method in the conventional technology in which the raw data is simply normalized for learning, this method improves efficiency and effects of training and learning.

In an optional embodiment, if the number of neuron output vectors is greater than the number of vector dimensions of the raw data, the obtaining the transformation matrix based on the interactive information formula and the second target function includes: obtaining a close approximation formula for the interactive information formula; and obtaining the transformation matrix based on the close approximation formula and the second target function.

If the number N of neuron output vectors is greater than the number K of vector dimensions of the raw data, for example, when N is far greater than K, the following formula may be used for a close approximation to the interactive information I (where the random variables include X, T, and R, and the interactive information I is denoted as I(R;X|T)), and the close approximation formula I_{G} for I(R;X|T) is expressed as follows:

$$I ( R ; X \vert T ) \approx {I}_{G} = \frac{1}{2} {〈 ln ( det ( \frac{G ( x , t )}{2 π e} ) ) 〉}_{x , t} + H ( X \vert T )$$

where det(⋅) represents a matrix determinant, H(X|T)=− [symbol] ln p(x|t) [symbol] _{x,t} conditional entropy of X under a condition T, and G(x,t) is expressed as follows:

$$\{ \begin{matrix}G ( x , t ) = J ( x , t ) + P ( x , t ) \\ J ( x , t ) = {〈 \frac{\partial ln p ( r \vert x , t )}{\partial x} \frac{\partial ln p ( r \vert x , t )}{\partial {x}^{T}} 〉}_{r \vert x , t} \\ P ( x , t ) = \frac{\partial ln p ( x \vert t )}{\partial x} \frac{\partial ln p ( x \vert t )}{\partial {x}^{T}}\end{matrix} .$$

I_{G} in the above formula is substituted into the following CSP transformation formula as the interactive information I:

Minimize L(V)=V^{T}Σ̅₁V subject to V^{T}(Σ̅₁+Σ̅₁)V=I.

The transformation matrix V is obtained by solving the target function L(V). After the transformation matrix V is obtained, transformed data \hat{x} after the CSP transformation on the input vector x is expressed as \hat{x}=V^{T}x.

In the above steps, a target function based on conditional mutual information maximization is constructed. Compared with the conventional technology in which target functions are based on squared error and cross entropy, this embodiment can greatly improve efficiency and performance of learning and training in a neural population coding network model.

In an optional embodiment, the updating the first matrix according to a preset gradient descent update rule, to obtain a second matrix includes: updating the first matrix according to the preset gradient descent update rule, to obtain a third matrix; determining the number of iterations, where the number of iterations is used to indicate the number of times of updating the first matrix according to the preset gradient descent update rule; and determining whether the number of iterations reaches a preset number; and if the number of iterations reaches the preset number, outputting the third matrix as the second matrix, or if the number of iterations does not reach the preset number, assigning the third matrix to the first matrix, and returning to the step of updating the first matrix according to the preset gradient descent update rule, to obtain a third matrix.

The foregoing preset gradient descent update rule may be as follows:

$$\{ \begin{matrix}{C}^{t + 1} = {C}^{t} + {μ}_{t} \frac{{dC}^{t}}{dt} \\ \frac{{dC}^{t}}{dt} = - \frac{dQ [ {C}^{t} ]}{{dC}^{t}} + {{C}^{t} ( \frac{dQ [ {C}^{t} ]}{{dC}^{t}} )}^{T} {C}^{t}\end{matrix}$$

where the data label t is the number of iterations, the learning rate parameter μₜ=vₜ/κₜ, varies with the number of iterations t, and 0<v₁<1, t=1, . . . , tₘₐₓ,

$${κ}_{t} = \frac{1}{{K}_{1}} {\sum }_{k = 1}^{K} \frac{‖ ∇ {C}^{t} ( : , k ) ‖}{‖ {C}^{t} ( : , k ) ‖} ,$$

and
μ∇C^{t}(:,k)∥ represent a modulus value of a gradient vector of the first matrix C.

The preset number of times is tₘₐₓ, that is, a maximum number of iterations of the first matrix. According to the gradient descent update rule, the first matrix C^{t} is updated to the third matrix C^{t+1}. Whether the number t+1 of iterations of the third matrix is equal to tₘₐₓ is determined; and if the number t+1 is equal to tₘₐₓ, the third matrix C^{t+1} is C^{tmax}. To be specific, the finally optimized weight parameter C^{tmax} (that is, C^{opt}) is obtained after C^{t} is iterated tₘₐₓ times, and the finally optimized weight parameter C^{opt} is output as the above second matrix. If the number t+1 of iterations does not reach tₘₐₓ, the first matrix keeps being iterated according to the gradient descent update rule, until the number of iterations reaches a preset maximum number of times to obtain the finally optimized weight parameter C^{opt}. For example, the preset number of times is 3, according to the gradient descent update rule, C² is obtained based on C¹, and iteration goes on, to obtain C³ based on C². The number of iterations with C³ reaches the preset number of times, so that C³ is output as the second matrix of the finally optimized weight parameter.

This embodiment proposes an adaptive gradient descent method, which provides a higher training efficiency than that in a random gradient descent method in the conventional technology. In addition, a system using the above method to obtain the optimized parameter C^{opt} may further be used for classifying recognition. A class of an input may be determined by calculating an amount of output information after neural population coding transformation on an input stimulus.

In an optional embodiment, before the updating the first matrix according to the preset gradient descent update rule, to obtain a third matrix, the method further includes: calculating a derivative of the first target function with respect to the first matrix.

Specifically, the derivative of the first target function Q[C] with respect to C is expressed as follows:

$$\frac{dQ [ C ]}{dC} = - {〈 sign ( t ) \hat{x} {ω}^{T} 〉}_{\hat{x} \vert t}$$

$$where$$

$$ω = {( {ω}_{1} , … , {ω}_{{K}_{1}} )}^{T} , {ω}_{k} = \frac{\partial ln {g}^{′} ( {d}_{k} )}{\partial {d}_{k}} = β ( 1 - {g}^{′} ( {d}_{k} ) ) ,$$

k=1, 2, . . . , E, and E denotes the number of output features.

It should be noted that, the expression of the derivative of the first target function Q[C] with respect to C is a part of the above gradient descent update rule.

In an optional embodiment, the updating the first target function based on the second matrix includes: performing an orthogonal transformation on the second matrix, to obtain an orthogonal result; and updating a value of the first target function based on the orthogonal result.

In an optional embodiment, the orthogonal transformation is a Gram-Schmidt orthogonal transformation.

The CSP transformation is performed on the raw data, so that noise in the raw data can be filtered out, and the second matrix is restricted to be orthogonal. This greatly improves robustness and efficiency of training and learning in the neural population coding network model.

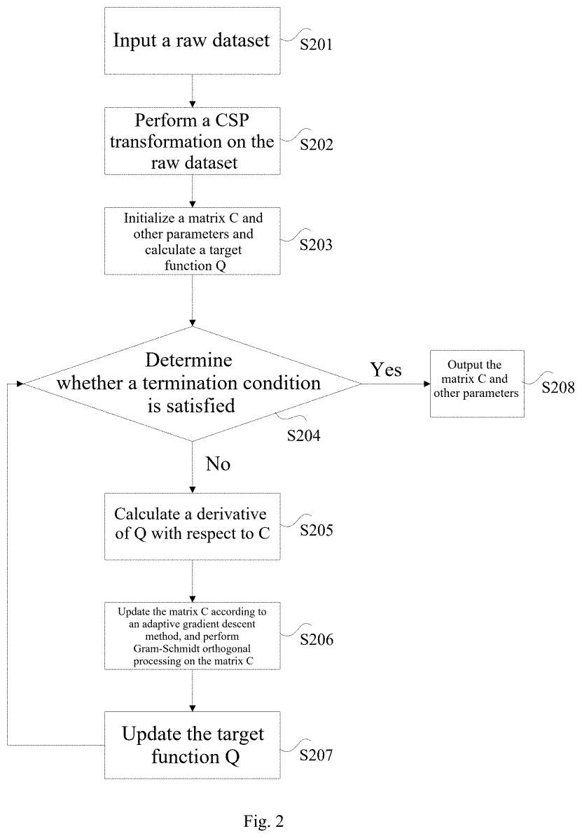

FIG. 2 is a flowchart of an optional data processing method based on neural population coding according to an embodiment of the present disclosure. A dataset used is an MNIST dataset of handwritten digits (FIG. 3 is an exemplary diagram of the MNIST dataset). The dataset includes 60,000 grayscale handwritten example images, which are classified into 10 classes (from 0 to 9) with a size of 28×28 each. In this embodiment, the 60,000 training example images are used as an input original training dataset. As shown in FIG. 2, the method includes the following steps.

Step S201: A raw dataset is inputted.

Step S202: Preprocessing of a common spatial pattern transformation is performed on a raw dataset x, to obtain transformed data \hat{x}=V^{T}x, where V is a transformation matrix obtained based on the common spatial pattern transformation.

Step S203: A matrix C and other parameters are initialized, and a target function Q is calculated:

$$\{ \begin{matrix}minimize Q [ C ] = - {〈 {\sum }_{k = 1}^{K} ln ( {g}^{′} ( {d}_{k} ) ) 〉}_{\hat{x} \vert t} \\ subject to {CC}^{T} = {I}_{{K}_{0}}\end{matrix} \\ where \\ {g}_{k} ( {d}_{k} ) = \frac{1}{β} ln ( 1 + {e}^{β {d}_{k}} ) , {g}^{′} ( {d}_{k} ) = \frac{\partial g ( {d}_{k} )}{\partial {d}_{k}} = \frac{1}{1 + {e}^{- β {d}_{k}}} ,$$

dₖ=sign(t)cₖ^{T}\hat{x}−m, β and m are non-negative constants, and m can be regarded as a margin parameter.

A maximum number of iterations is set to tₘₐₓ=50 as a termination condition.

Step S204: Whether the maximum number of iterations is reached is determined. If the maximum number of iterations is reached, step S208 is then performed, and a finally optimized parameter matrix C and other parameters are output; or if the maximum number of iterations is not reached, step S205 is then performed.

Step S205: A derivative of Q with respect to C is calculated:

$$\frac{dQ [ C ]}{dC} = - {〈 sign ( t ) \hat{x} {ω}^{T} 〉}_{\hat{x} \vert t}$$

$$where$$

$$ω = {( {ω}_{1} , … , {ω}_{{K}_{1}} )}^{T} , {ω}_{k} = \frac{\partial ln {g}^{′} ( {d}_{k} )}{\partial {d}_{k}} = β ( 1 - {g}^{′} ( {d}_{k} ) ) ,$$

k=1, 2, . . . , E, and E denotes the number of output features.

Step S206: The matrix C is updated according to an adaptive gradient descent method, and Gram-Schmidt orthogonalization is performed on the matrix C:

$$\{ \begin{matrix}{C}^{t + 1} = {C}^{t} + {μ}_{t} \frac{{dC}^{t}}{dt} \\ \frac{{dC}^{t}}{dt} = - \frac{dQ [ {C}^{t} ]}{{dC}^{t}} + {{C}^{t} ( \frac{dQ [ {C}^{t} ]}{{dC}^{t}} )}^{T} {C}^{t}\end{matrix}$$

where t is the number of iterations, the learning rate parameter μₜ=vₜ/κₜ varies with the number of iterations t, and 0<vₜ<1, t=1, . . . , tₘₐₓ,

$${κ}_{t} = \frac{1}{{K}_{1}} {\sum }_{k = 1}^{K} \frac{‖ ∇ {C}^{t} ( : , k ) ‖}{‖ {C}^{t} ( : , k ) ‖} , and ‖ ∇ {C}^{t} ( : , k ) ‖$$

represent a modulus value of a gradient vector of the first matrix C.

Gram-Schmidt orthogonalization is performed on the matrix C^{t+1}, and the finally optimized parameter C^{opt} can be obtained after tₘₐₓ times of iterations.

Step S207: A value of the target function Q is updated, and return to step S204 of determining whether the number of iterations reaches the maximum number of iterations.

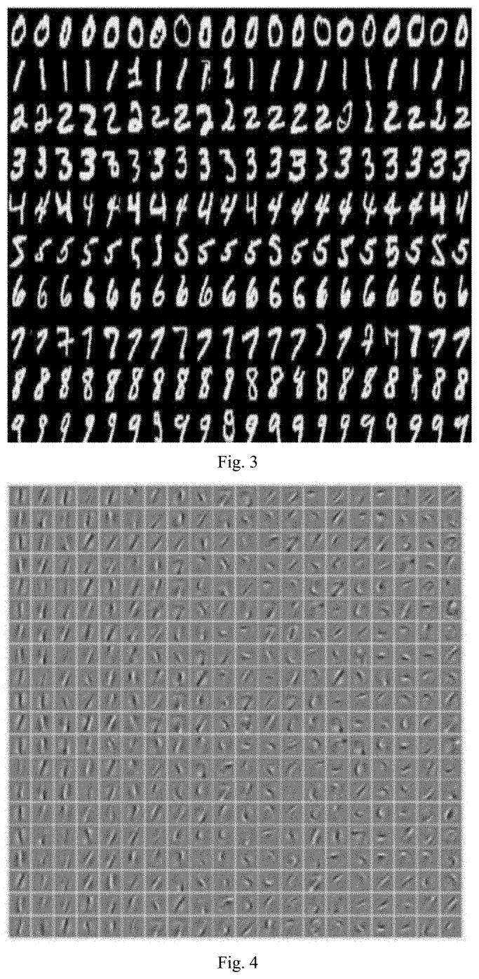

After tₘₐₓ times of iterations of the matrix C, the optimized weight parameter C^{opt} in this embodiment can be obtained. FIG. 4 is a visualized schematic diagram of the weight parameter C^{opt}. The target function Q is updated based on the optimized weight parameter C^{opt}. In this embodiment, 10,000 test example sets in the MNIST dataset are classified directly by using feature parameters learned on a single-layer network, and a recognition precision is as high as 98.4%, compared with a recognition precision of 94.5% for an SVM method with currently best classification effects in a single-layer neural network structure.

In this embodiment, neural population coding and an approximation formula for conditional mutual information are used, and the neural population coding network model and learning algorithm based on a principle of conditional mutual information maximization are proposed. The supervised learning target function based on conditional mutual information maximization and the method for rapid optimization of a model parameter, which can be used in image recognition, natural language processing, voice recognition, signal analysis, and other products and application scenarios, are further proposed. Learning effects and efficiency of the supervised representation learning algorithm proposed in this embodiment are far better than effects and efficiency of another method (such as the SVM method). The supervised representation learning algorithm can be useful in learning not only large data samples but also small data samples. Efficiency, performance, and robustness of supervised representation learning can be remarkably improved without significantly increasing calculation complexity.

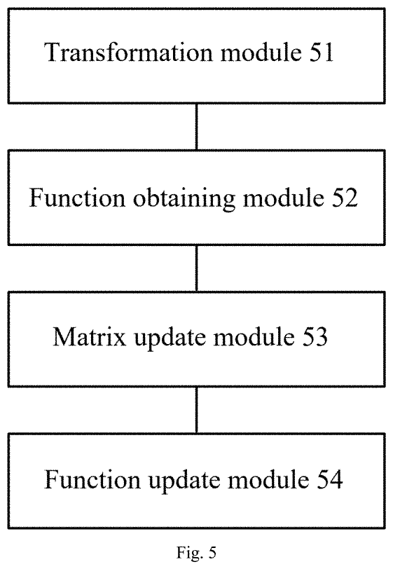

According to an embodiment of the present disclosure, an embodiment of a data processing apparatus based on neural population coding is provided. FIG. 5 is a schematic diagram of a data processing apparatus based on neural population coding according to an embodiment of the present disclosure. As shown in FIG. 5, the apparatus includes: a transformation module 51 configured to obtain raw data and perform a common spatial pattern transformation on the raw data to obtain transformed data; a function obtaining module 52 configured to obtain, based on the transformed data, a first target function including a first matrix, where the first target function is a target function of a neural population coding network model, and the first matrix is a weight parameter of the target function of the neural population coding network model; a matrix update module 53 configured to: update the first matrix according to a preset gradient descent update rule, to obtain a second matrix; and a function update module 54 configured to update the first target function based on the second matrix.

The apparatus further includes a module for performing other method steps of the data processing method based on neural population coding in Embodiment 1.

According to an embodiment of the present disclosure, an embodiment of a storage medium is provided. The storage medium includes a stored program, and when the program is run, a device having the storage medium is controlled to perform the foregoing data processing method based on neural population coding.

According to an embodiment of the present disclosure, a processor is provided. The processor is configured to run a program, and when the program is run, the foregoing data processing method based on neural population coding is performed.

The serial numbers of the above embodiments of the present disclosure are merely for description, and do not represent the superiority or inferiority of the embodiments.

In the embodiments of the present disclosure, descriptions of each embodiment have different focuses. For a part in an embodiment not described in detail, refer to related descriptions of other procedures.

In several embodiments provided in the present application, it should be understood that the disclosed technical content may be implemented in other ways. The apparatus embodiment described above is merely exemplary. For example, division into the units may be logical function division, and there may be another division manner during actual implementation. For example, a plurality of units or components may be combined or integrated into another system, or some features may be ignored or not executed. In addition, the displayed or discussed mutual couplings or direct couplings or communication connections may be implemented by some interfaces. The indirect couplings or communication connections between units or modules may be implemented in electrical or other forms.

The units illustrated as separate components can be or cannot be physically separated, and the components illustrated as units can be or cannot be physical units. That is to say, the components can be positioned at one place or distributed on a plurality of units. The object(s) of the solutions of embodiments can be achieved by selecting some of or all the units therein based on actual requirements.

In addition, the functional units in the embodiments of the present disclosure may be integrated into one processing unit, or each of the units may exist alone physically, or two or more units may be integrated into one unit. The integrated unit may be implemented in the form of hardware or in the form of software functional units.

If the integrated unit is implemented in the form of software functional units and sold or used as independent products, the unit may be stored in a computer-readable storage medium. Based on such understanding, the essence of the technical solutions of the present disclosure, the part contributing to the prior art, or all or some of the technical solutions may be embodied in the form of a software product. The computer software product is stored in a storage medium which includes several instructions to enable a computer device (which may be a personal computer, a server, a network device, etc.) to perform all or some of the steps of the method described in various embodiments of the present disclosure. The above storage medium includes: a USB flash drive, a read-only memory (ROM), a random access memory (RAM), a removable disk, a magnetic disk, an optical disc, or other various media that can store program code.

The above descriptions are merely preferable implementations of the present disclosure. It should be noted that for those of ordinary skills in the prior art, some refinements and modification may be further made without departing from the principle of the present disclosure, and the refinements and modification shall fall within the protection scope of the present disclosure.

What is claimed is:

1. A data processing method based on neural population coding, comprising:
obtaining raw data and performing a common spatial pattern transformation on the raw data to obtain transformed data;
obtaining, based on the transformed data, a first target function comprising a first matrix, wherein the first target function is a target function of a neural population coding network model, and the first matrix is a weight parameter of the target function of the neural population coding network model;
updating the first matrix according to a preset gradient descent update rule, to obtain a second matrix; and
updating the first target function based on the second matrix.

2. The method according to claim 1, wherein the obtaining raw data and performing common spatial pattern transformation on the raw data to obtain transformed data comprises:
obtaining an input vector representing the raw data and a neuron output vector;
determining an interactive information formula based on the input vector of the raw data and the neuron output vector;
determining a second target function comprising a covariance matrix and a transformation matrix;
obtaining the transformation matrix based on the interactive information formula and the second target function; and
transforming the raw data into the transformed data based on the transformation matrix.

3. The method according to claim 2, wherein if the number of neuron output vectors is greater than the number of vector dimensions of the raw data, the obtaining the transformation matrix based on the interactive information formula and the second target function comprises:
obtaining a close approximation formula for the interactive information formula; and
obtaining the transformation matrix based on the close approximation formula and the second target function.

4. The method according to claim 1, wherein the updating the first matrix according to a preset gradient descent update rule, to obtain a second matrix comprises:
updating the first matrix according to the preset gradient descent update rule, to obtain a third matrix;
determining the number of iterations, wherein the number of iterations is used to indicate the number of times of updating the first matrix according to the preset gradient descent update rule; and
determining whether the number of iterations reaches a preset number; and if the number of iterations reaches the preset number, outputting the third matrix as the second matrix, or if the number of iterations does not reach the preset number, assigning the third matrix to the first matrix, and returning to the step of updating the first matrix according to the preset gradient descent update rule, to obtain a third matrix.

5. The method according to claim 4, wherein before the updating the first matrix according to the preset gradient descent update rule, to obtain a third matrix, the method further comprises:
calculating a derivative of the first target function with respect to the first matrix.

6. The method according to claim 1, wherein the updating the first target function based on the second matrix comprises:
performing an orthogonal transformation on the second matrix, to obtain an orthogonal result; and
updating a value of the first target function based on the orthogonal result.

7. The method according to claim 6, wherein
the orthogonal transformation is a Gram-Schmidt orthogonal transformation.

8. A data processing apparatus based on neural population coding, wherein the apparatus comprises:
a transformation module configured to obtain raw data and perform a common spatial pattern transformation on the raw data to obtain transformed data;
a function obtaining module configured to obtain, based on the transformed data, a first target function comprising a first matrix, wherein the first target function is a target function of a neural population coding network model, and the first matrix is a weight parameter of the target function of the neural population coding network model;
a matrix update module configured to: update the first matrix according to a preset gradient descent update rule, and perform orthogonalization, to obtain a second matrix; and
a function update module configured to update the first target function based on the second matrix.

9. A non-transitory computer readable storage medium having stored thereon one or more programs which, when executed by a computing device having one or more processors, cause the computing device to perform a data processing method based on neural population coding, wherein the data processing method comprises:
obtaining raw data and performing a common spatial pattern transformation on the raw data to obtain transformed data;
obtaining, based on the transformed data, a first target function comprising a first matrix, wherein the first target function is a target function of a neural population coding network model, and the first matrix is a weight parameter of the target function of the neural population coding network model;
updating the first matrix according to a preset gradient descent update rule, to obtain a second matrix; and
updating the first target function based on the second matrix.

10. The medium according to claim 9, wherein the obtaining raw data and performing common spatial pattern transformation on the raw data to obtain transformed data comprises:
obtaining an input vector representing the raw data and a neuron output vector;
determining an interactive information formula based on the input vector of the raw data and the neuron output vector;
determining a second target function comprising a covariance matrix and a transformation matrix;
obtaining the transformation matrix based on the interactive information formula and the second target function; and
transforming the raw data into the transformed data based on the transformation matrix.

11. The medium according to claim 10, wherein if the number of neuron output vectors is greater than the number of vector dimensions of the raw data, the obtaining the transformation matrix based on the interactive information formula and the second target function comprises:
obtaining a close approximation formula for the interactive information formula; and
obtaining the transformation matrix based on the close approximation formula and the second target function.

12. The medium according to claim 9, wherein the updating the first matrix according to a preset gradient descent update rule, to obtain a second matrix comprises:
updating the first matrix according to the preset gradient descent update rule, to obtain a third matrix;
determining the number of iterations, wherein the number of iterations is used to indicate the number of times of updating the first matrix according to the preset gradient descent update rule; and
determining whether the number of iterations reaches a preset number; and if the number of iterations reaches the preset number, outputting the third matrix as the second matrix, or if the number of iterations does not reach the preset number, assigning the third matrix to the first matrix, and returning to the step of updating the first matrix according to the preset gradient descent update rule, to obtain a third matrix.

13. The medium according to claim 12, wherein before the updating the first matrix according to the preset gradient descent update rule, to obtain a third matrix, the method further comprises:
calculating a derivative of the first target function with respect to the first matrix.

14. The medium according to claim 9, wherein the updating the first target function based on the second matrix comprises:
performing an orthogonal transformation on the second matrix, to obtain an orthogonal result; and
updating a value of the first target function based on the orthogonal result.

15. A processor configured to perform a data processing method comprising:
obtaining raw data and performing a common spatial pattern transformation on the raw data to obtain transformed data;
obtaining, based on the transformed data, a first target function comprising a first matrix, wherein the first target function is a target function of a neural population coding network model, and the first matrix is a weight parameter of the target function of the neural population coding network model;
updating the first matrix according to a preset gradient descent update rule, to obtain a second matrix; and
updating the first target function based on the second matrix.

16. The processor according to claim 15, wherein the obtaining raw data and performing common spatial pattern transformation on the raw data to obtain transformed data comprises:
obtaining an input vector representing the raw data and a neuron output vector;
determining an interactive information formula based on the input vector of the raw data and the neuron output vector;
determining a second target function comprising a covariance matrix and a transformation matrix;
obtaining the transformation matrix based on the interactive information formula and the second target function; and
transforming the raw data into the transformed data based on the transformation matrix.

17. The processor according to claim 16, wherein if the number of neuron output vectors is greater than the number of vector dimensions of the raw data, the obtaining the transformation matrix based on the interactive information formula and the second target function comprises:
obtaining a close approximation formula for the interactive information formula; and
obtaining the transformation matrix based on the close approximation formula and the second target function.

18. The processor according to claim 15, wherein the updating the first matrix according to a preset gradient descent update rule, to obtain a second matrix comprises:
updating the first matrix according to the preset gradient descent update rule, to obtain a third matrix;
determining the number of iterations, wherein the number of iterations is used to indicate the number of times of updating the first matrix according to the preset gradient descent update rule; and
determining whether the number of iterations reaches a preset number; and if the number of iterations reaches the preset number, outputting the third matrix as the second matrix, or if the number of iterations does not reach the preset number, assigning the third matrix to the first matrix, and returning to the step of updating the first matrix according to the preset gradient descent update rule, to obtain a third matrix.

19. The processor according to claim 18, wherein before the updating the first matrix according to the preset gradient descent update rule, to obtain a third matrix, the method further comprises:
calculating a derivative of the first target function with respect to the first matrix.

20. The processor according to claim 15, wherein the updating the first target function based on the second matrix comprises:
performing an orthogonal transformation on the second matrix, to obtain an orthogonal result; and
updating a value of the first target function based on the orthogonal result.
